(19) United States
(12) Patent Application Publication
(10) Pub. No.: US 2020/0048480 A1
(43) Pub. Date: Feb. 13, 2020

(54) PHOTOCURABLE INKJET INK

(71) Applicant: JNC CORPORATION, Tokyo (JP)

(72) Inventors: Kohsuke YOSHITOMI, ICHIHARA-SHI, CHIBA (JP); Shinta MOROKOSHI, ICHIHARA-SHI, CHIBA (JP); Toshiyuki TAKAHASHI, ICHIHARA-SHI, CHIBA (JP); Hisao OIKAWA, ICHIHARA-SHI, CHIBA (JP)

(73) Assignee: JNC CORPORATION, Tokyo (JP)

(21) Appl. No.: 16/608,205

(22) PCT Filed: Apr. 25, 2018
(86) PCT No.: PCT/JP2018/016725

§ 371 Date: Oct. 25, 2019

(30) Foreign Application Priority Data
Apr. 27, 2017 (JP) 2017-088128

(51) Int. Cl. C09D 11/101; C09D 11/38; C09D 11/107; B41M 5/00

(52) U.S. Cl. CPC C09D 11/101; C09D 11/38; G02B 3/00; B41M 5/0023; C09D 11/107

(57) ABSTRACT

An object of the invention is to provide a photocurable inkjet ink useful for producing microlenses and electronic components, and having low volatility.

The photocurable inkjet ink of the invention contains polyfunctional (meth)acrylate (A), monofunctional (meth)acrylate (B) having nonvolatility of 75% or more and viscosity (25° C.) of 1 to 70 mPa·s in evaluation method 1, and photopolymerization initiator (C); and having viscosity (at 25° C.) of 1 to 100 mPa·s.

### TECHNICAL FIELD

The invention relates to a photocurable inkjet ink preferably used for producing an optical instrument such as a video display apparatus. More specifically, the invention relates to a microlens formation ink used for an optical system for enhancing three-dimensional image formation of an image or light use efficiency of a device.

Moreover, the invention relates to a photocurable inkjet ink preferably used for producing an electronic component such as a semiconductor apparatus and a flexible wiring board. More specifically, the invention relates to an ink for forming an insulating material that forms a pattern of a buffer coat, a redistribution insulating material, a dam material or an underfill material for a wafer level package, a cover lay for the flexible wiring board, or the like.

### BACKGROUND ART

An application has been studied on a microlens as a light guide plate for a video display apparatus in which a fine uneven structure is utilized, or as a material of a 3D image display device or a counterfeit prevention device because the microlens can express a special visual effect (for example, Patent literature Nos. 1 and 2).

Such a microlens has been so far formed by injection molding using a mold. However, upon producing a small volume of microlenses in great varieties by using the above method, a mold according to a product design needs to be remade, and an increase in the number of production steps has been a problem. Moreover, in recent years, higher definition of a pattern shape has been required in an electronic component or the like. In order to achieve micromachining of the pattern shape, for example, upon forming a semiconductor integrated circuit pattern by a photolithography technology, higher precision of the pattern formation has been achieved.

Meanwhile, as a production method having a high degree of design freedom, a method of directly forming a microlens on a surface of a substrate by using an inkjet method has been proposed (for example, Patent literature Nos. 3 and 4). Such a microlens production method using an inkjet method is expected in view of no change in the number of production steps even for small-volume production in great varieties because patterning can be easily controlled by a personal computer or the like, and capability of suppressing production cost and the like.

Moreover, upon producing the electronic component such as a semiconductor package and the flexible wiring board, a dry film resist or a liquid photoresist has been so far used as a protective film for protecting a conductor such as metal wiring forming a predetermined circuit pattern formed on a substrate, and electrodes, and the substrate.

However, such a method for forming the protective film has problems of requiring a long time and many costs for preparing a photomask owing to a photolithography method, and an increase in equipment investment and complexing steps because of necessity of pattern exposure using the photomask.

In recent years, in order to solve the above problems, a method of directly applying the ink onto the substrate by using the inkjet method to form the protective film has been developed (for example, Patent literature No. 10). The method is expected in view of small equipment investment because of capability of eliminating necessity of pattern exposure that has been required so far, and a high yield of a material.

In order to achieve a fine pattern shape using the inkjet method, reduction in viscosity of the ink to be used has been required. In order to reduce the viscosity of the ink, addressing of simultaneously using a monofunctional low-molecular-weight monomer as a reactive diluent with a photocurable resin component has been performed. As a compound that has been used as the reactive diluent, a great number of compounds such as an acrylic monomer and a vinyl-based monomer are known. Above all, acrylates are generally excellent in photocurability, but on the other hand, has strong odor and strong skin irritation, and therefore a photocurable resin containing the monomer has a disadvantage of adversely affecting a work environment. Moreover, acrylates having lower viscosity have high volatility, and has a problem of difficulty in forming the fine pattern shape.

A compound in which the odor and the skin irritation are reduced by modifying the above acrylate monomers with alkylene oxide or ε-caprolactone has been developed, but such disadvantages have remained in the resulting modified acrylate as reduction in a curing rate or hardness of a cured material and an increase in ink viscosity.

Patent literature No. 5 discloses that a composition containing a reactive oligomer being urethane poly(meth)acrylate obtained by allowing polyol to react with polyisocyanate and hydroxyl group-containing (meth)acrylate is effective in reducing the odor and the skin irritation, but the viscosity is at thousands or more mPa·s, and therefore the compound is hard to use as an inkjet ink.

Patent literature No. 6 discloses that a composition having surface tension of 25 to 35 mN/m is effective in fine droplet formation using the inkjet method, but no sufficient discussion is made on volatility of a monomer.

Patent literature No. 7 discloses an inkjet ink containing trifunctional (meth)acrylate (A), monofunctional (meth)acrylate (B), photopolymerization initiator (C), and surfactant (D) having a photocrosslinkable functional group, which is related to an inkjet ink used for substrate treatment for forming a microlens, and is not designated to be used for a microlens itself.

Patent literature No. 8 discloses an ink composition for forming a microlens, containing compound (A) having a specific structure, any other radical polymerizable compound (B) and photopolymerization initiator (C). Patent literature No. 9 discloses an inkjet ink containing (meth)acrylamide (A) having a specific structure, (meth)acrylamide having a cyclic structure, urethane (meth)acrylate (C) and photopolymerization initiator (D). Both disclose the ink composition for facilitating a design of a height and a shape of the microlens, and describe nothing on volatility of the monomer.

### CITATION LIST

### Patent Literature

Patent literature No. 1: JP 2016-539381 A.

Patent literature No. 2: JP 2016-109714 A.

Patent literature No. 3: JP 2000-180605 A.

Patent literature No. 4: JP 2004-240294 A.

Patent literature No. 5: JP 3316040 B.

Patent literature No. 6: JP 2015-009171 A.

Patent literature No. 7: JP 5477150 B.

Patent literature No. 8: JP 2015-063666 A.

Patent literature No. 9: JP 5974784 B.

Patent literature No. 10: JP 6028731 B.

### SUMMARY OF INVENTION

### Technical Problem

Under the above-described situation, an object of the invention is to provide a photocurable ink having low viscosity at which printing can be made by an inkjet method, and having low volatility at which a fine pattern shape of a microlens, a protective film or the like can be formed.

### Solution to Problem

The present inventors have found that a photocurable inkjet ink containing polyfunctional (meth)acrylate (A), monofunctional (meth)acrylate (B) having low volatility, and photopolymerization initiator (C); and having viscosity (at 25° C.) of 1 to 100 mPa·s satisfies low volatility and low viscosity suitable for forming a fine microlens and a fine protective film, and have completed the invention based on the finding.

Moe specifically, the invention includes items described below.

Item 1. A photocurable inkjet ink, containing polyfunctional (meth)acrylate (A), monofunctional (meth)acrylate (B) having nonvolatility of 75% or more and viscosity (25° C.) of 1 to 70 mPa·s of an evaluation solution in evaluation method 1, and photopolymerization initiator (C); and having viscosity (at 25° C.) of 1 to 100 mPa·s, wherein

### Evaluation Method 1

monofunctional (meth)acrylate (B) and pentaerythritol tetra (tri)acrylate are mixed at a weight ratio of 25:45 in monofunctional (meth)acrylate (B):pentaerythritol tetra (tri)acrylate to prepare an evaluation solution.

(1) Weight of a 5 cm×5 cm glass substrate is measured.

(2) The evaluation solution is added dropwise onto the glass substrate in step (1), and applied to be 25 mg±2 mg in an application weight error by spin coating.

(3) Weight of the glass substrate applied with the evaluation solution in step (2) is measured.

(4) The weight measured in step (1) is subtracted from the weight measured in step (3) to calculate application weight of the evaluation solution.

(5) The glass substrate applied with the evaluation solution in step (3) is heated for 15 minutes on a hot plate at 50° C.

(6) Weight of the glass substrate after being heated in step (5) is measured, and a residue of the evaluation solution is calculated by subtracting the weight in step (1).

(7) Nonvolatility is calculated from the following calculation formula:

Nonvolatility %=(residue/application weight)×100.

Item 2. The photocurable inkjet ink according to item 1, wherein polyfunctional (meth)acrylate (A) is at least one compound selected from the group of compounds represented by formula (1) or formula (3).

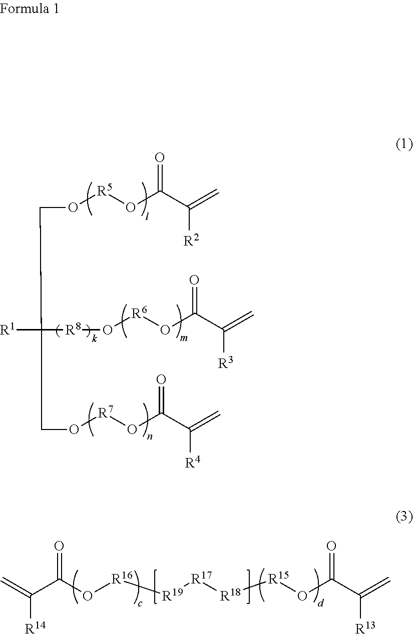

wherein, in formula (1), R¹ is hydrogen, alkyl having 1 to 6 carbons or hydroxymethyl, R², R³ and R⁴ are independently hydrogen or methyl, R⁵, R⁶, R⁷ and R⁸ are independently alkylene having 1 to 6 carbons, k is 0 or 1, and 1, m and n are independently an integer from 0 to 10; moreover, in formula (3), R¹³ and R¹⁴ are independently hydrogen or methyl, R¹⁵ and R¹⁶ are independently alkylene having 1 to 6 carbons, R¹⁷ is a divalent organic group or a single bond, and R¹⁸ and R¹⁹ are independently —O— or a single bond, in which, when R¹⁷ is a single bond, one of R¹⁸ and R¹⁹ is —O— or both thereof is a single bond; and c and d are independently an integer from 0 to 10.

Item 3. The photocurable inkjet ink according to item 2, wherein polyfunctional (meth)acrylate (A) is a compound in which, in formula (1), k is 0 or 1, and a sum: 1+m+n is 0, or a compound in which, in formula (3), R¹⁵ and R¹⁶ each are alkylene having 2 carbons.

Item 4. The photocurable inkjet ink according to item 3, wherein polyfunctional (meth)acrylate (A) is at least one compound selected from glycerol tri(meth)acrylate, trimethylolethane tri(meth)acrylate, trimethylolpropane tri(meth)acrylate, pentaerythritol tri(meth)acrylate, bisphenol A ethylene oxide-modified diacrylate and bisphenol F ethylene oxide-modified diacrylate.

Item 5. The photocurable inkjet ink according to item 4, wherein polyfunctional (meth)acrylate (A) is pentaerythritol tri(meth)acrylate or bisphenol F ethylene oxide-modified diacrylate.

Item 6. The photocurable inkjet ink according to any one of items 1 to 5, wherein monofunctional (meth)acrylate (B) is a compound having one group selected from a vinyl ether group and an allyl ether group.

Item 7. The photocurable inkjet ink according to item 6, wherein monofunctional (meth)acrylate (B) is a compound represented by formula (2).

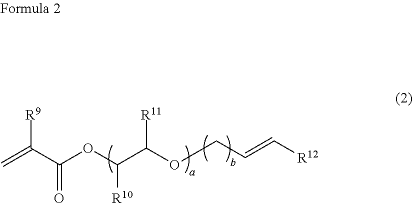

wherein, in formula (2), R⁹ is hydrogen or methyl, R¹⁰ and R¹¹ are independently hydrogen or methyl, a is an integer from 1 to 10, b is 0 or 1, and R¹² is hydrogen or alkyl having 1 to 11 carbons

Item 8. The photocurable inkjet ink according to item 7, wherein, in formula (2), R¹⁰ and R¹¹ are hydrogen, a is an integer of 1 or 2, b is 0, and R¹² is hydrogen.

Item 9. The photocurable inkjet ink according to item 8, wherein monofunctional (meth)acrylate (B) is 2-vinyloxyethyl (meth)acrylate or 2-(2-vinyloxyethoxy)ethyl (meth)acrylate.

Item 10. The photocurable inkjet ink according to item 9, wherein monofunctional (meth)acrylate (B) is 2-(2-vinyloxyethoxy)ethyl (meth)acrylate.

Item 11. The photocurable inkjet ink according to any one of items 1 to 10, containing 10 to 75% by weight of polyfunctional (meth)acrylate (A), 20 to 90% by weight of monofunctional (meth)acrylate (B), and 1 to 20% by weight of photopolymerization initiator (C) (in which a total is not more than 100% by weight), based on total weight of the photocurable inkjet ink.

Item 12. A cured film, formed of a cured material of the photocurable inkjet ink according to any one of items 1 to 11.

Item 13. A microlens, formed of the cured material of the photocurable inkjet ink according to any one of items 1 to 12.

Item 14. A protective film, formed of the cured material of the photocurable inkjet ink according to any one of items 1 to 12.

Item 15. An optical component, having the microlens according to item 13.

Item 16. An electronic component, having the protective film according to item 14.

Item 17. A display device, having the component according to item 15 or 16.

### Advantageous Effects of Invention

A photocurable inkjet ink of the invention is formed of a monomer component having low volatility, and therefore continuous jettability and rejettability are improved when inkjet printing is performed, and a fine microlens shape and a fine protective film pattern after printing can be maintained. Accordingly, if the photocurable inkjet ink of the invention is used, fine patterns can be integrated, and therefore a small-sized and high-performance electronic component can be preferably produced. Above all, the ink can be preferably used for preparing a fine microlens and a high-definition protective film.

### DESCRIPTION OF EMBODIMENTS

Hereinafter, the invention will be specifically described.

### 1. Photocurable Inkjet Ink

The invention relates to a photocurable inkjet ink containing polyfunctional (meth)acrylate (A), monofunctional (meth)acrylate (B) having low volatility, and photopolymerization initiator (C); and having viscosity (at 25° C.) of about 1 to about 100 mPa·s.

The photocurable inkjet ink of the invention is preferably colorless and transparent for use in an electronic component requiring an optical function. However, the photocurable inkjet ink is not limited thereto unless the optical function of a cured film obtained is significantly impaired, or the electronic component mounted is adversely affected.

Moreover, the photocurable inkjet ink of the invention can contain a compound having any other radical polymerizable double bond, a solvent, a polymerization inhibitor, a flame retardant, an ultraviolet light absorber, a light stabilizer, an antioxidant, an antistatic agent, a surfactant or the like. The term “compound having any other radical polymerizable double bond” herein means a compound having a radical polymerizable double bond other than polyfunctional (meth)acrylate (A) and monofunctional (meth)acrylate (B) having low volatility as shown below.

### 1.1. (Meth)Acrylate

In the present description, the term “(meth)acrylate” is used for representing both or one of acrylate and methacrylate.

In a curing reaction of (meth)acrylate, a double bond of a (meth)acryloyl group causes radical polymerization, and therefore a “functional” part is the (meth)acryloyl group, and the term “monofunctional” means a compound having one (meth)acryloyl group, and the term “polyfunctional” means a compound having 2 or more (meth)acryloyl groups.

Hereinafter, each component described above will be described.

### 1.1.1. Polyfunctional (Meth)Acrylate (A)

Polyfunctional (meth)acrylate (A) of the invention is not particularly limited, as long as the compound having such a structure is applied, but the compound preferably has a structure represented by formula (1) or formula (3). Curability of the photocurable ink is improved by using polyfunctional (meth)acrylate (A) of the invention.

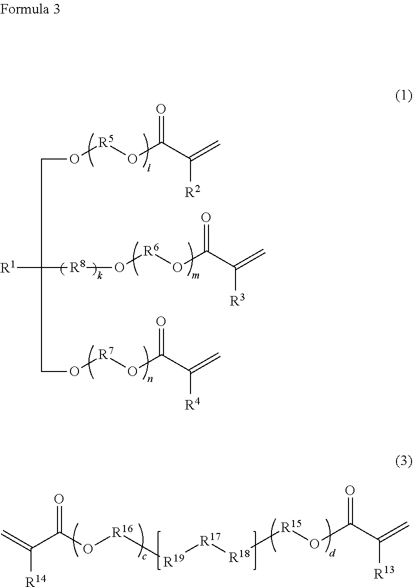

wherein, in formula (1), R¹ is hydrogen, alkyl having 1 to 6 carbons or hydroxymethyl, R², R³ and R⁴ are independently hydrogen or methyl, R⁵, R⁶, R⁷ and R⁸ are independently alkylene having 1 to 6 carbons, k is 0 or 1, and 1, m and n are independently an integer from 0 to 10.

Moreover, in formula (3), R¹³ and R¹⁴ are independently hydrogen or methyl, R¹⁵ and R¹⁶ are independently alkylene having 1 to 6 carbons, R¹⁷ is a divalent organic group or a single bond, and R¹⁸ and R¹⁹ are independently —O— or a single bond, in which, when R¹⁷ is a single bond, one of R¹⁸ and R¹⁹ is —O— or both thereof are a single bond; and c and d are independently an integer from 0 to 10.

For example, when R¹⁷ is a single bond, R¹⁸ and R¹⁹ directly form a bond into (—R¹⁸-R¹⁹—).

Moreover, in formula (1), k is preferably 0 or 1, and a sum: 1+m+n is preferably 0.

Specific examples of the compound having the structure represented by formula (1) include glycerol tri(meth)acrylate, trimethylolethane tri(meth)acrylate, trimethylolpropane tri(meth)acrylate, pentaerythritol tri(meth)acrylate, EO-modified glycerol tri(meth)acrylate, PO-modified glycerol tri(meth)acrylate, trimethylolpropane EO-modified tri(meth)acrylate, trimethylolpropane PO-modified tri(meth)acrylate, pentaerythritol EO-modified tri(meth)acrylate and pentaerythritol PO-modified tri(meth)acrylate.

Moreover, in formula (3), R¹⁵ and R¹⁶ each are preferably alkylene having 2 carbons from a viewpoint of compatibility of the ink, and further c and d are particularly preferably 2 from a viewpoint of adhesion with a substrate. Specific examples of the divalent organic group constituting R¹⁷ include a group having a straight-chain or cyclic alkylene structure having 1 to 20 carbons, and a group having a phenylene structure, and also a group having a heterocyclic structure such as an isocyanurate structure.

Specific examples of the compound having the structure represented by formula (3) include tricyclodecane di(meth)acrylate, tricyclodecane dimethanol di(meth)acrylate, bisphenol A EO-modified di(meth)acrylate, bisphenol F EO-modified di(meth)acrylate, tris(2-hydroxyethyl)isocyanurate di(meth)acrylate, trimethylolpropane di(meth)acrylate, pentaerythritol di(meth)acrylate, ethylene glycol di(meth)acrylate, tetraethylene glycol di(meth)acrylate, polytetramethylene glycol diacrylate, polyethylene glycol di(meth)acrylate, propylene glycol diacrylate, dipropylene glycol diacrylate, polypropylene glycol diacrylate, butylene glycol di(meth)acrylate, dibutylene glycol di(meth)acrylate, polybutylene glycol di(meth)acrylate, 1,4-butanediol di(meth)acrylate, 1,6-hexanediol di(meth)acrylate, 1,9-nonanediol di(meth)acrylate and neopentyl glycol di(meth)acrylate.

In addition, the term “EO-modified” represents ethylene oxide modification, and the term “PO-modified” represents propylene oxide modification, and the number of moles in parentheses represents the number of moles of ethylene oxide or propylene oxide to be added per molecule.

Above all, in view of excellent photocurability and ease of adjustment of a viscosity range preferable as the inkjet ink, pentaerythritol tri(meth)acrylate is particularly preferred. Moreover, from viewpoints of compatibility of the ink and adhesion with the substrate, bisphenol A EO-modified diacrylate or bisphenol F EO-modified diacrylate is preferred. Above all, bisphenol F EO-modified diacrylate is particularly preferred from a viewpoint of adhesion with an inorganic substrate.

Polyfunctional (meth)acrylate (A) may be one kind of compound, or a mixture of two or more kinds of compounds different from each other.

A content of polyfunctional (meth)acrylate (A) is preferably about 10 to about 75% by weight based on the total amount of the photocurable inkjet ink of the invention because the viscosity can be adjusted according to an application in which the ink is used, and in consideration of a balance with other characteristics, the content is further preferably about 15 to 70% by weight, and is still further preferably about 20 to about 65% by weight (in which a total of (A) to (C) is not more than 100% by weight).

### 1.1.2. Monofunctional (Meth)Acrylate (B) Having Low Volatility

Monofunctional (meth)acrylate (B) having low volatility is not particularly limited, as long as the nonvolatility in evaluation method 1 is about 75% or more and the viscosity (25° C.) is about 1 to about 70 mPa·s. Volatilization of the photocurable ink can be suppressed by using monofunctional (meth)acrylate (B) having low volatility.

### Evaluation Method 1

An evaluation solution is prepared by mixing monofunctional (meth)acrylate (B) and pentaerythritol tetra (tri)acrylate at a weight ratio of 25:45 in monofunctional (meth)acrylate (B):pentaerythritol tetra (tri)acrylate. Pentaerythritol tetra (tri)acrylate is a mixture of pentaerythritol tetraacrylate and pentaerythritol triacrylate, and M305 made by Toagosei Co., Ltd. can be used, for example.

The mixture of pentaerythritol triacrylate and pentaerythritol tetraacrylate has a weight ratio of (55 to 63):(37 to 45) in pentaerythritol triacrylate:pentaerythritol tetraacrylate, and a mixture of monofunctional (meth)acrylate (B) and the mixture has a weight ratio of 25:45 in monofunctional (meth)acrylate (B): the mixture.

(1) Weight of a 5 cm×5 cm glass substrate is measured.

(2) The evaluation solution is added dropwise onto the glass substrate in step (1), and applied to be 25 mg±2 mg in an application weight error by spin coating.

(3) Weight of the glass substrate applied with the evaluation solution in step (2) is measured.

(4) The weight measured in step (1) is subtracted from the weight measured in step (3) to calculate application weight of the evaluation solution.

(5) The glass substrate applied with the evaluation solution in step (3) is heated for 15 minutes on a hot plate at 50° C.

(6) Weight of the glass substrate after being heated in step (5) is measured, and a residue of the evaluation solution is calculated by subtracting the weight in step (1).

(7) Nonvolatility is calculated from the following calculation formula.

Nonvolatility %=(residue/application weight)×100

Specific examples of such a compound include 4-hydroxybutyl (meth)acrylate, tetrahydrofurfuryl alcohol acrylic acid multimer ester, and a compound represented by formula (2).

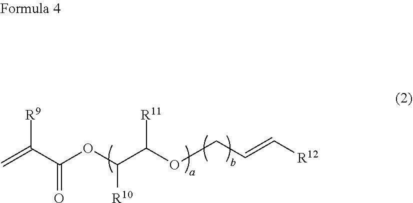

In formula (2), R⁹ is hydrogen or methyl, R¹⁰ and R¹¹ are independently hydrogen or methyl, a is an integer from 1 to 10, b is 0 or 1, and R¹² is hydrogen or alkyl having 1 to 11 carbons.

Above all, in view of low volatility and ease of adjustment of a viscosity range preferable as the inkjet ink, the compound having the structure represented by formula (2) is preferred, and 2-vinyloxyethyl (meth)acrylate or 2-(2-vinyloxyethoxy)ethyl (meth)acrylate is particularly preferred.

Monofunctional (meth)acrylate (B) may be one kind of compound, or a mixture of two or more kinds of compounds different from each other.

A content of monofunctional (meth)acrylates (B) is preferably about 20 to about 90% by weight and then about 20 to about 89% by weight based on the total amount of the photocurable inkjet ink of the invention because the viscosity can be adjusted according to an application in which the ink is used, and in consideration of a balance with other characteristics, the content is further preferably about 25 to about 85% by weight, and is still further preferably about 30 to about 80% by weight (in which a total of (A) to (C) is not more than 100% by weight).

### 1.1.3. Compound Having any Other Radical Polymerizable Double Bond

To the photocurable inkjet ink of the invention, a compound having any other radical polymerizable double bond may be added in a range in which photocurability, adhesion, transmittance and strength are not adversely affected.

The compound having any other radical polymerizable double bond include a (meth)acrylate monomer other than polyfunctional (meth)acrylate (A) and monofunctional (meth)acrylate (B) having low volatility, a low-molecular-weight compound having a radical polymerizable double bond other than (meth)acrylate, and a resin having a radically polymerizable unsaturated bond such as an unsaturated polyester resin, a polyester (meth)acrylate resin, an epoxy (meth)acrylate resin and a urethane (meth)acrylate resin.

Specific examples of the (meth)acrylate monomer include methyl (meth)acrylate, ethyl (meth)acrylate, propyl (meth)acrylate, butyl (meth)acrylate, pentyl (meth)acrylate, hexyl (meth)acrylate, lauryl (meth)acrylate, stearyl (meth)acrylate, 2-(2-ethoxyethoxy)ethyl acrylate, methoxypolyethylene glycol acrylate, methoxypolyethylene glycol acrylate, polyalkylene glycol acrylate, ditrimethylol propane tetra(meth)acrylate, pentaerythritol diacrylate monostearate, pentaerythritol tetra(meth)acrylate, dipentaerythritol diacrylate, dipentaerythritol tri(meth)acrylate, dipentaerythritol penta(meth)acrylate, dipentaerythritol hexa(meth)acrylate, ε-caprolactone-added trimethylolpropane tri(meth)acrylate, ε-caprolactone-added ditrimethylolpropane tetra(meth)acrylate, ε-caprolactone-added pentaerythritol tetra(meth)acrylate and ε-caprolactone-added dipentaerythritol hexa(meth)acrylate.

Specific examples of the low-molecular-weight compound having the radical polymerizable double bond other than (meth)acrylate include crotonic acid, α-chloroacrylic acid, cinnamic acid, maleic acid, fumaric acid, N-vinylformamide, methyl 2-allyloxymethyl acrylate, a polymethyl methacrylate macromonomer, N-cyclohexylmaleimide, N-phenylmaleimide, styrene, (meth)acrylamide, N,N-dimethyl (meth)acrylamide, N,N-diethyl (meth)acrylamide, N,N-dimethylaminopropyl (meth)acrylamide, N-isopropyl (meth)acrylamide and N-hydroxyethyl (meth)acrylamide.

Specific examples of the unsaturated polyester resin include a material prepared by dissolving a condensation product (unsaturated polyester) obtained by an esterification reaction between polyhydric alcohol and unsaturated polybasic acid (and saturated polybasic acid, when necessary) into a polymerizable monomer. Such unsaturated polyester can be produced by allowing polycondensation between unsaturated acid such as maleic anhydride and diol such as ethylene glycol. Specific examples thereof include a material produced by allowing, as an acid component, polybasic acid having a polymerizable unsaturated bond such as fumaric acid, maleic acid and itaconic acid, or anhydride thereof to react with, as an alcohol component, polyhydric alcohol such as ethylene glycol, propylene glycol, diethylene glycol, dipropylene glycol, 1,2-butanediol, 1,3-butanediol, 1,5-pentanediol, 1,6-hexandiol, 2-methyl-1,3-propanediol, 2,2-dimethyl-1,3-propanediol, cyclohexane-1,4-dimethanol, an ethylene oxide adduct of bisphenol A and a propylene oxide adduct of bisphenol A, and when necessary, adding, as an acid component, polybasic acid having no polymerizable unsaturated bond such as phthalic acid, isophthalic acid, terephthalic acid, tetrahydrophthalic acid, adipic acid and sebacic acid, or anhydride thereof.

Specific examples of the polyester (meth)acrylate resin include (1) (meth)acrylate obtained by allowing polyester of a terminal carboxyl group obtained from saturated polybasic acid and/or unsaturated polybasic acid, and polyhydric alcohol to react with an epoxy compound containing an α,β-unsaturated carboxylic acid ester group, (2) (meth)acrylate obtained by allowing polyester of a terminal carboxyl group obtained from saturated polybasic acid and/or unsaturated polybasic acid, and polyhydric alcohol to react with hydroxyl group-containing acrylate, and (3) (meth)acrylate obtained by allowing polyester of a terminal hydroxyl group obtained from saturated polybasic acid and/or unsaturated polybasic acid, and polyhydric alcohol to react with (meth)acrylic acid.

Specific examples of the saturated polybasic acid used as a raw material of polyester (meta) acrylate include polybasic acid having no polymerizable unsaturated bond such as phthalic acid, isophthalic acid, terephthalic acid, tetrahydrophthalic acid, adipic acid and sebacic acid, or anhydride thereof, and polymerizable unsaturated polybasic acid such as fumaric acid, maleic acid and itaconic acid, or anhydride thereof. Further, a polyhydric alcohol component is the same as in the unsaturated polyester.

Specific examples of the epoxy (meth)acrylate resin include a compound (vinyl ester) having a polymerizable unsaturated bond formed by a ring-opening reaction between a compound having a glycidyl group (epoxy group) and a carboxyl group of a carboxyl compound having a polymerizable unsaturated bond such as acrylic acid. Ordinarily, the material prepared by dissolving the compound into the polymerizable monomer is used.

Examples of the vinyl ester include a compound produced by a publicly-known method is used. Specific examples of the compound having the glycidyl group (epoxy group) include epoxy (meth)acrylate obtained by allowing an epoxy resin to react with unsaturated monobasic acid, for example, acrylic acid or methacrylic acid.

Moreover, flexibility may be provided by allowing various epoxy resins to react with bisphenol (for example, A type) or dibasic acid such as adipic acid, sebacic acid and dimer acid (HARIDIMER 270S: Harima Chemicals Group, Inc.).

Specific examples of the compound having the glycidyl group (epoxy group) of the epoxy resin as a raw material include bisphenol A diglycidyl ether and a high molecular weight homolog thereof, and novolak type glycidyl ethers. Specific examples thereof may include, in addition to (meth)acrylic acid, bisphenol (for example, A type) or a compound containing a reactant of dibasic acid such as adipic acid, sebacic acid and dimer acid (HARIDIMER 270S: Harima Chemicals Group, Inc.).

Specific examples of the urethane (meth)acrylate resin include a radical polymerizable unsaturated group-containing oligomer obtained by allowing polyisocyanate to react with a polyhydroxy compound or polyhydric alcohols, and then to react with a hydroxyl group-containing (meth)acrylic compound and, when necessary, a hydroxyl group-containing allyl ether compound.

Specific examples of the polyisocyanate include 2,4-tolylene diisocyanate and an isomer thereof, diphenylmethane diisocyanate, hexamethylene diisocyanate, hydrogenated xylylene diisocyanate, isophorone diisocyanate, xylylene diisocyanate, dicyclohexylmethane diisocyanate, naphthalene diisocyanate, triphenylmethane triisocyanate, Burnock D-750 and Chrisvon NK (trade name; made by Dainippon Ink & Chemicals, Inc.), Desmodur L (trade name; made by Sumitomo Bayer Urethane Co., Ltd.), Coronate L (trade name; made by Nippon Polyurethane Industry Co., Ltd.), Takenate D102 (trade name; made by MITSUI TAKEDA CHEMICALS, INC.), and Isonate 143L (trade name; made by Mitsubishi Chemical Corporation).

Examples of the polyhydroxy compound include polyester polyol and polyether polyol. Specific examples thereof include a glycerol-ethylene oxide adduct, a glycerol-propylene oxide adduct, a glycerol tetrahydrofuran adduct, a glycerol ethylene oxide-propylene oxide adduct, a trimethylolpropane-ethylene oxide adduct, a trimethylolpropane-propylene oxide adduct, a trimethylolpropane-tetrahydrofuran adduct, a trimethylolpropane-ethylene oxide propylene oxide adduct, a dipentaerythritol-ethylene oxide adduct, a dipentaerythritol-propylene oxide adduct, a dipentaerythritol-tetrahydrofuran adduct and a dipentaerythritol-ethylene oxide propylene oxide adduct.

Specific examples of the polyhydric alcohols include ethylene glycol, diethylene glycol, triethylene glycol, polyethylene glycol, propylene glycol, dipropylene glycol, polypropylene glycol, 2-methyl-1,3-propanediol, 1,3-butanediol, an adduct of bisphenol A with propylene oxide or ethylene oxide, 1,2,3,4-tetrahydroxybutane, glycerol, trimethylolpropane, 1,3-butanediol, 1,2-cyclohexane glycol, 1,3-cyclohexane glycol, 1,4-cyclohexane glycol, para-xylene glycol, bicyclohexyl-4,4-diol, 2,6-decalin glycol and 2,7-decalin glycol.

The hydroxyl group-containing (meth)acrylic compound is not particularly limited, but hydroxyl group-containing (meth)acrylic acid ester is preferred. Specific examples thereof include 2-hydroxyethyl (meth)acrylate, 2-hydroxypropyl (meth)acrylate, 3-hydroxybutyl (meth)acrylate, polyethylene glycol mono(meth)acrylate, polypropylene glycol mono(meth)acrylate, tris(hydroxyethyl) isocyanurate di(meth)acrylate and pentaerythritol tri(meth)acrylate.

The compound having any other radical polymerizable double bond may be in one kind or in a mixture of two or more kinds. A content of the compound having any other radical polymerizable double bond is preferably about 20% by weight or less based on the total amount of the photocurable inkjet ink of the invention in consideration of a balance with other characteristics.

### 1.2. Photopolymerization Initiator (C)

The photocurable inkjet ink of the invention contains photopolymerization initiator (C). Photopolymerization initiator (C) is not particularly limited, as long as a compound that can generate a radical by irradiation with ultraviolet light or visible light is applied thereto.

Specific examples of photopolymerization initiator (C) include benzophenone, Michler's ketone, 4,4′-bis(diethylamino)benzophenone, xanthone, thioxanthone, isopropylxanthone, 2,4-diethylthioxanthone, 2-ethylanthraquinone, acetophenone, 2-hydroxy-2-methylpropiophenone, 2-hydroxy-2-methyl-4′-isopropylpropiophenone, 1-hydroxycyclohexylphenyl ketone, isopropyl benzoin ether, isobutyl benzoin ether, 2,2-diethoxyacetophenone, 2,2-dimethoxy-2-phenylacetophenone, camphor quinone, benzanthrone, 2-methyl-1-[4-(methylthio)phenyl]-2-morpholinopropane-1-one, 2-benzyl-2-dimethylamino-1-(4-morpholinophenyl)-butanone-1,ethyl 4-dimethylaminobenzoate, isoamyl 4-dimethylaminobenzoate, 4,4′-di(t-butylperoxycarbonyl)benzophenone, 3,4,4′-tri(t-butylperoxycarbonyl)benzophenone, 3,3′,4,4′-tetra(t-butylperoxycarbonyl)benzophenone, 3,3′,4,4′-tetra(t-hexylperoxycarbonyl)benzophenone, 3,3′-di(carbomethoxy-4,4′-di(t-butylperoxycarbonyl)benzophenone, 3,4′-di(carbomethoxy-4,3′-di(t-butylperoxycarbonyl)benzophenone, 4,4′-di(carbomethoxy-3,3′-di(t-butylperoxycarbonyl)benzophenone, 2-(4′-methoxystyryl)-4,6-bis(trichloromethyl)-s-triazine, 2-(3′,4′-dimethoxystyryl)-4,6-bis(trichloromethyl)-s-triazine, 2-(2′,4′-dimethoxystyryl)-4,6-bis(trichloromethyl)-s-triazine, 2-(2′-methoxystyryl)-4,6-bis(trichloromethyl)-s-triazine, 2-(4′-pentyloxystyryl)-4,6-bis(trichloromethyl)-s-triazine, 4-[p-N,N-di(ethoxycarbonylmethyl)]-2,6-di(trichloromethyl-s-triazine, 1,3-bis(trichloromethyl)-5-(2′-chlorophenyl)-s-triazine, 1,3-bis(trichloromethyl)-5-(4′-methoxyphenyl)-s-triazine, 2-(p-dimethylaminostyryl)benzoxazole, 2-(p-dimethylaminostyryl)benzthiazole, 2-mercaptobenzothiazole, 3,3′-carbonylbis(7-diethylaminocoumarin), 2-(o-chlorophenyl)-4,4′,5,5′-tetraphenyl-1,2′-biimidazole, 2,2′-bis(2-chlorophenyl)-4,4′,5,5′-tetrakis(4-carboethoxyphenyl)-1,2′-biimidazole, 2,2′-bis(2,4-dichlorophenyl)-4,4′,5,5′-tetraphenyl-1,2′-biimidazole, 2,2′-bis(2,4-dibromophenyl)-4,4′,5,5′-tetraphenyl-1,2′-biimidazole, 2,2′-bis(2,4,6-trichlorophenyl)-4,4′,5,5′-tetraphenyl-1,2′-biimidazole, 3-(2-methyl-2-dimethylaminopropionyl)carbazole, 3,6-bis(2-methyl-2-morpholinopropionyl)-9-n-dodecylcarbazole, 1-hydroxycyclohexyl phenyl ketone, bis(η⁵-2,4-cyclopentadiene-1-yl)-bis(2,6-difluoro-3-(1H-pyrrole-1-yl)-phenyl)titanium, 2-(dimethylamino)-2-[(4-methylphenyl)methyl]-1-[4-(4-morpholinyl)phenyl]-1-butanone, bis(2,4,6-trimethylbenzoyl)phenyl phosphine oxide and 2,4,6-trimethylbenzoyldiphenyl phosphine oxide.

Photopolymerization initiator (C) may be in one kind or in a mixture of two or more kinds.

A content of photopolymerization initiator (C) is preferably about 1 to about 20% by weight based on the total amount of the photocurable ink of the invention because the initiator is excellent in photocurability to ultraviolet light, further preferably about 2 to about 15% by weight, and still further preferably about 3 to about 10% by weight.

### 1.3. Solvent

The photocurable inkjet ink of the invention may contain a solvent. Specific examples of the solvent that can be used in the invention include diethyl ether, tetrahydrofuran, diphenyl ether, dimethoxybenzene, acetone, methanol, ethanol, isopropanol, butyl alcohol, t-butyl alcohol, benzyl alcohol, methyl ethyl ketone, methyl isobutyl ketone, acetonitrile, propionitrile, benzonitrile, ethylene carbonate, propylene carbonate, ethyl acetate, isobutyl acetate, butyl acetate, butyl propionate, ethyl lactate, methyl oxyacetate, ethyl oxyacetate, butyl oxyacetate, methyl methoxyacetate, ethyl methoxyacetate, butyl methoxyacetate, methyl ethoxyacetate, ethyl ethoxyacetate, methyl 3-oxypropionate, ethyl 3-oxypropionate, methyl 3-methoxypropionate, ethyl 3-methoxypropionate, methyl 3-ethoxypropionate, ethyl 3-ethoxypropionate, methyl 2-oxypropionate, ethyl 2-oxypropionate, propyl 2-oxypropionate, methyl 2-methoxypropionate, ethyl 2-methoxypropionate, propyl 2-methoxypropionate, methyl 2-ethoxypropionate, ethyl 2-ethoxypropionate, methyl 2-oxy-2-methylpropionate, ethyl 2-oxy-2-methylpropionate, methyl 2-methoxy-2-methylpropionate, ethyl 2-ethoxy-2-methylpropionate, methyl pyruvate, ethyl pyruvate, propyl pyruvate, methyl acetoacetate, ethyl acetoacetate, methyl 2-oxobutanate, ethyl 2-oxobutanate, methyl 2-hydroxyisobutyrate, dioxane, ethylene glycol, ethylene glycol monomethyl ether, ethylene glycol monoethyl ether, diethylene glycol, triethylene glycol, propylene glycol, dipropylene glycol, tripropylene glycol, 1,4-butanediol, ethylene glycol monoisopropyl ether, ethylene glycol monobutyl ether, propylene glycol monomethyl ether, propylene glycol monoethyl ether acetate, propylene glycol monoethyl ether, propylene glycol monoethyl ether acetate, propylene glycol monopropyl ether acetate, dipropylene glycol monoethyl ether acetate, dipropylene glycol monobutyl ether acetate, ethylene glycol monobutyl ether acetate, cyclohexanone, cyclopentanone, diethylene glycol monomethyl ether, diethylene glycol monomethyl ether acetate, diethylene glycol monoethyl ether, diethylene glycol monoethyl ether acetate, diethylene glycol monobutyl ether, diethylene glycol monobutyl ether acetate, diethylene glycol dimethyl ether, diethylene glycol diethyl ether, diethylene glycol ethylmethyl ether, tetraethylene glycol dimethyl ether, toluene, xylene, anisole, γ-butyrolactone, N,N-dimethylacetamide, N,N-dimethylformamide, N-methyl-2-pyrrolidone and dimethylimidazolidinone.

The solvent used for the photocurable inkjet ink of the invention may be in one kind or in a mixture of two or more kinds.

If a content of the solvent in the ink of the invention is about 0 to about 60% by weight based on 100% by weight (in terms of a solid content) of the total amount of the ink, a jetting hole of an inkjet head becomes hard to clog upon applying the ink by an ink jet method, and therefore such a case is preferred. In consideration of a balance with other characteristics, the content is further preferably about 0 to about 40% by weight, and still further preferably about 0 to about 20% by weight.

### 1.4. Polymerization Inhibitor

The photocurable inkjet ink of the invention may contain a polymerization inhibitor for improving storage stability. Specific examples of the polymerization inhibitor include 4-methoxyphenol, hydroquinone and phenothiazine. Above all, phenothiazine is preferred because an increase in viscosity is small even during long-term storage.

The polymerization inhibitor used for the photocurable inkjet ink of the invention may be in one kind or in a mixture of two or more kinds.

If a content of the polymerization inhibitor is about 1% by weight or less based on the total amount of the inkjet ink of the invention, an increase in viscosity is small even in long-term storage, and therefore such a case is preferred, and in consideration of a balance with other characteristics, the content is further preferably about 0.5% by weight or less, and still further preferably about 0.1% by weight or less.

### 1.5. Flame Retardant

The photocurable inkjet ink of the invention may contain a flame retardant. If the ink contains the flame retardant, a cured film obtained has high flame retardancy, and therefore such a case is preferred. The flame retardant is not particularly limited, as long as a compound that can provide flame retardancy is applied thereto, but from a viewpoint of low toxicity, low pollution and safety, an organic phosphorus-based flame retardant is preferably used.

Specific examples of the organic phosphorus-based flame retardant include triphenyl phosphate, tricresyl phosphate, trixylenyl phosphate, cresyl phenyl phosphate, 2-ethylhexyl diphenyl phosphate, 9,10-dihydro-9-oxa-10-phosphaphenanthrene-10-oxide, 10-(2,5-dihydroxyphenyl)-1 OH-9-oxa-10-phosphaphenanthrene-10-oxide and fused 9,10-dihydro-9-oxa-10-phosphaphenanthrene-10-oxide.

A content of the flame retardant is not particular limited, and in consideration of a balance with other characteristics, the content is preferably about 40% by weight or less based on the total amount of the photocurable inkjet ink of the invention.

### 1.6. Ultraviolet Light Absorber and a Light Stabilizer

The photocurable inkjet ink of the invention may contain an ultraviolet light absorber and a light stabilizer (HALS) for preventing the resulting cured film or the like from being deteriorated by light from a backlight or the like.

Specific examples of the ultraviolet light absorber include a benzotriazole compound such as 2-(5-methyl-2-hydroxyphenyl)benzotriazol, 2-(3,5-di-t-butyl-2-hydroxyphenyl)benzotriazol, 2-(3,5-di-t-butyl-2-hydroxyphenyl)-5-chlorobenzotriazole and 2-(3,5-di-t-amyl-2-hydroxyphenyl)benzotriazol, a triazine compound such as 2-(4,6-diphenyl-1,3,5-triazine-2-yl)-5-[(hexyl)oxy]-phenol, a benzophenone compound such as 2-hydroxy-4-n-octyloxy benzophenone, and an oxalic acid anilide compound such as 2-ethoxy-2′-ethyl oxalic acid bisanilide.

Specific examples of the light stabilizer (HALS) include TINUVIN (registered trademark) 5100, TINUVIN 292 (compound name: bis(1,2,2,6,6-pentamethy-1-4-piperidinyl)sebacate, methyl(1,2,2,6,6-pentamethyl-4-piperidinyl)sebacate), TINUVIN 152 (compound name: 2,4-bis[N-butyl-N-(1-cyclohexyloxy-2,2,6,6-tetramethylpiperidine-4-yl)amino]-6-(2-hydroxyethylamine)-1,3,5-triazine), TINUVIN 144 (compound name: bis(1,2,2,6,6-pentamethyl-4-piperidinyl)-[[3,5-bis(1,1-dimethylethyl)-4-hydroxyphenyl]-methyl]butyl malonate), TINUVIN 123 (compound name: decanedioic acid, bis(2,2,6,6-tetramethyl-1-(octyloxy)-4-piperidinyl)ester, a reaction product (in the presence of 1,1-dimethyethylhydroperoxide and octane), TINUVIN 111 FDL (about 50%, TINUVIN 622, compound name: (butanedioic acid polymer (in the presence of (4-hydroxy-2,2,6,6-tetramethyl piperidinyl-yl)ethanol), about 50%, CHIMASSORB 119, compound name: N—N′—N″—N′″-tetrakis(4,6-bis(butyl-(N-methyl-2,2,6,6-tetramethylpiperidine-4-yl)amino)triazine-2-yl)-4,7-diazadecane-1,10-diamine) (all made by BASF SE), or ADEKASTAB LA series (made by ADEKA CORPORATION), specifically, LA-52, LA-57, LA-62, LA-67 and the like.

The ultraviolet light absorber and the light stabilizer used for the photocurable inkjet ink of the invention may be one kind of compound, or a mixture of two or more kinds of compounds.

A content of the ultraviolet light absorber and the light stabilizer is not particularly limited, and in consideration of a balance with other characteristics, the content is preferably about 5% by weight or less based on the total amount of the photocurable inkjet ink of the invention.

### 1.7. Antioxidant

The photocurable inkjet ink of the invention may contain an antioxidant for preventing oxidation of the resulting cured film or the like.

Specific examples of the antioxidant include a hindered phenolic compound such as pentaerythritol tetrakis[3-(3,5-di-t-butyl-4-hydroxyphenyl)propionate], triethylene glycol bis-[3-(3-t-butyl-5-methyl-4-hydroxyphenyl)propionate], 1,6-hexandiol-bis[3-(3,5-di-t-butyl-4-hydroxyphenyl)propionate], octadecyl-3-(3,5-di-t-butyl-4-hydroxyphenyl)propionate and 3,5-di-t-buthyl-4-hydroxybenzylphosphonate diethyl ester; an amine compound such as n-butylamine, triethylamine and diethylaminomethyl methacrylate; a sulfur-based compound such as dilauryl-3,3′-thiodipropionate, dimyristyl-3,3′-thiodipropionate and distearyl-3,3′-thiodipropionate; and a phosphorus-based compound such as triphenyl phosphite, diphenyl isodecyl phosphite, phenyl di-isodecyl phosphite, tris(nonylphenyl)phosphite, diisodecyl pentaerythritol phosphite, tris(2,4-di-t-butylphenyl)phosphite, cyclic neopentanetetrailbis(octadecyl)phosphite, cyclic neopentanetetraylbis(2,4-di-t-butylphenyl)phosphite, cyclic neopentanetetraylbis(2,4-di-t-butyl-4-methylphenyl)phosphite, bis[2-t-butyl-6-methyl-4-{2-(octadecyloxycarbonyl)ethyl}phenyl]hydrogen phosphite and oxaphosphaphenanthrene oxides such as 9,10-dihydro-9-oxa-10-phosphaphenanthrene-10-oxide, 10-(3,5-di-t-butyl-4-hydroxybenzyl)-9,10-dihydro-9-oxa-10-phosphaphenanthrene-10-oxide and 10-decyloxy-9,10-dihydro-9-oxa-10-phosphaphenanthrene-10-oxide.

The antioxidant used for the photocurable inkjet ink of the invention may be one kind of compound, or a mixture of two or more kinds of compounds.

A content of the antioxidant is not particularly limited, and in consideration of a balance with other characteristics, the content is preferably about 5% by weight or less based on the total amount of the photocurable inkjet ink of the invention.

### 1.8. Antistatic Agent

The photocurable inkjet ink of the invention may contain an antistatic agent. The antistatic agent prevents a surface of the resulting cured film from being charged by static electricity to suppress dust or the like from being attached to the surface.

The antistatic agent is not particularly limited, and any antistatic agent known to those skilled in the art may be used, such as ethoxyglyceryl fatty acid ester, a quaternary amine compound, an aliphatic amine derivative, an alkyl sulfonate compound, an epoxy resin (such as polyethylene oxide), siloxane, or other alcohol derivatives such as poly(ethylene glycol) ester and poly(ethylene glycol) ether.

Specific examples of the antistatic agent include COLCOAT 200, COLCOAT 515, COLCOAT 1000 and COLCOAT WAS-15X (all made by COLCOAT CO., LTD.), Electrostripper-AC, Electrostripper-QN and Electrostripper-ME-2 (all made by Kao Corporation), FC-4400 (made by 3M Company), AC-ILA (made by Kakensangyou Corporation), IL-A2 and IL-AP3 (all made by Koei Chemical Co., Ltd.), PEL-20A, PEL-25, PEL-46, PEL-100, CIL-312 and CIL-313 (all made by Japan Carlit Co., Ltd.), Acrit 1SX-1055, Acrit 1SX-1060, Acrit 1SX-1090 and Acrit 1SX-3000 (all made by TAISEI FINE CHEMICAL CO., LTD.), DISPARLON 1121 (made by Kusumoto Chemicals, Ltd.), and PC-3662 and PC-6862 (all made by Marubishi Oil Chemical Co., Ltd.).

The antistatic agent used for the photocurable inkjet ink of the invention may be one kind of compound, or a mixture of two or more kinds of compounds.

A content of the antistatic agent is not particularly limited, and in consideration of a balance with other characteristics, if the content is about 10% by weight or less based on the total amount of the photocurable inkjet ink of the invention, such a case is preferred.

### 1.9. Surfactant

The photocurable inkjet ink of the invention may further contain a surfactant for the purpose of controlling wettability to an optical sheet, when necessary.

Specific examples of the surfactant include Polyflow No. 45, Polyflow KL-245, Polyflow No. 75, Polyflow No. 90 and Polyflow No. 95 (trade name, made by Kyoeisha Chemical Co., Ltd.), Disperbyk 161, Disperbyk 162, Disperbyk 163, Disperbyk 164, Disperbyk 166, Disperbyk 170, Disperbyk 180, Disperbyk 181, Disperbyk 182, BYK 300, BYK 306, BYK 310, BYK 320, BYK 330, BYK 342, BYK 344 and BYK 346 (trade name, BYK Japan KK), KP-341, KP-358, KP-368, KF-96-50CS and KF-50-100CS (trade name, made by Shin-Etsu Chemical Co., Ltd.), Surflon SC-101 and Surflon KH-40 (trade name, made by SEIMI CHEMICAL CO., LTD.), Futargent 222F, Futargent 251 and FTX-218 (trade name, made by NEOS COMPANY LIMITED), TEGO Rad 2100, 2200N, 2250, 2500, 2600 and 2700 (trade name, made by Evonik Degussa AG), EFTOP EF-351, EFTOP EF-352, EFTOP EF-601, EFTOP EF-801 and EFTOP EF-802 (trade name, made by Mitsubishi Materials Corporation), MEGAFAC F-171, MEGAFAC F-177, MEGAFAC F-444, MEGAFAC F-475, MEGAFAC F-477, MEGAFAC F-556, MEGAFAC R-08 and MEGAFAC R-30 (trade name, made by DIC Corporation), fluoroalkyl benzenesulfonate, fluoroalkyl carboxylate, fluoroalkyl polyoxyethylene ether, fluoroalkyl ammonium iodide, fluoroalkyl betaine, fluoroalkyl sulfonate, a perfluoroalkyl ethylene oxide adduct, diglycerol tetrakis(fluoroalkyl polyoxyethylene ether), fluoroalkyl trimethylammonium salt, fluoroalkyl aminosulfonate, polyoxyethylene nonylphenyl ether, polyoxyethylene octylphenyl ether, polyoxyethylene lauryl ether, polyoxyethylene oleyl ether, polyoxyethylene tridecyl ether, polyoxyethylene cetyl ether, polyoxyethylene stearyl ether, polyoxyethylene laurate, polyoxyethylene oleate, polyoxyethylene stearate, polyoxyethylene lauryl amine, sorbitan laurate, sorbitan palmitate, sorbitan stearate, sorbitan oleate, sorbitan fatty acid ester, polyoxyethylene sorbitan laurate, polyoxyethylene sorbitan palmitate, polyoxyethylene sorbitan stearate, polyoxyethylene sorbitan oleate, polyoxyethylene naphthyl ether, alkylbenzene sulfonate and alkyl diphenyl ether disulfonate.

The surfactant used for the photocurable inkjet ink of the invention may be one kind of compound or a mixture of two or more kinds of compounds.

If a content of the surfactant is about 2% by weight or less based on the total amount of the photocurable inkjet ink of the invention, wettability to the optical sheet can be effectively controlled, and therefore such a case is preferred.

### 1.10. Inkjet Ink

### 1.10.1. Method for Preparing an Inkjet Ink

The inkjet ink of the invention can be prepared by mixing respective components to be raw materials by a publicly-known method.

In particular, the inkjet ink of the invention is preferably prepared by mixing components (A) to (D) described above and other components, when necessary, and filtrating and degassing the resulting solution. The thus prepared inkjet ink of the invention is excellent in jettability during inkjet application. For the filtration, for example, a filter made of a fluorocarbon resin, polyethylene or polypropylene is used.

### 1.10.2. Viscosity of an Inkjet Ink

Viscosity (at 25° C.) of the inkjet ink of the invention as measured by a cone-plate type (E type) viscometer is about 1 to about 200 mPa·s, preferably about 2 to about 150 mPa·s, and further preferably about 3 to about 100 mPa·s. If the ink has the viscosity described above, jettability by an inkjet apparatus is improved when the inkjet ink of the invention is applied thereonto by the inkjet method.

Moreover, the viscosity of the inkjet ink of the invention at a temperature (preferably about 25 to about 120° C.) upon jetting the ink by the inkjet apparatus is preferably about 1 to about 30 mPa·s, further preferably about 2 to about 25 mPa·s, and particularly preferably about 3 to about 20 mPa·s.

When an inkjet ink having viscosity (at 25° C.) more than about 30 mPa·s is used, further stable jetting can be achieved by heating the inkjet head to reduce the viscosity of the inkjet ink during jetting the ink. When the inkjet ink is heated and jetted, the viscosity of the inkjet ink at a heating temperature (preferably about 40 to about 120° C.) is preferably about 1 to about 30 mPa·s, further preferably about 2 to about 25 mPa·s, and particularly preferably about 3 to about 20 mPa·s.

When the inkjet head is heated, an inkjet ink containing no solvent is preferably used.

### 1.10.3. Storage of an Inkjet Ink

If the inkjet ink of the invention is stored at about 4 to about 25° C., a change in viscosity during storage is small, and storage stability is improved.

### 2. Microlens and a Protective Film

The microlens and the protective film of the invention are formed of the ink of the invention described above. Specifically, the microlens and the protective film obtained by applying the ink of the invention onto a surface of the substrate by the inkjet method, and then curing the ink by irradiation with light such as ultraviolet light and visible light are preferred.

The microlens and the protective film of the invention are obtained by curing the ink of the invention, and therefore have an improved shape, and have improved optical characteristics even after a constant temperature and humidity test.

A quantity of light (light exposure) for irradiation when the ink is irradiated with ultraviolet light, visible light or the like depends on a composition of the photocurable ink. When the quantity is measured at a wavelength of UV-A (315 to 380 nm) by using an illumination meter (UVpad-E, made by Argo Corporation), the quantity is preferably about 100 to about 5,000 mJ/cm², further preferably about 100 to about 4,000 mJ/cm², and still further preferably about 100 to about 3,000 mJ/cm². Moreover, the wavelength of ultraviolet light, visible light or the like for irradiation is preferably about 200 to about 500 nanometers.

In addition, an exposure system is not particularly limited, as long as the system is an apparatus mounted with a high pressure mercury vapor lamp, an ultrahigh pressure mercury lamp, a metal halide lamp, a halogen lamp or the like to irradiate the ink with ultraviolet light, visible light or the like in the range of about 250 to about 500 nanometers.

Moreover, when necessary, the microlens and the protective film cured by irradiation with light may be further heated and calcinated, and heating and calcination at about 80 to about 250° C. for about 10 to about 60 minutes allow further firm curing of the microlens and the protective film.

The “substrate” onto which the ink of the invention is applied is not particularly limited, as long as the substrate can be an object onto which the ink of the invention is applied, and the shape is not limited to a flat plate form, and may be curved or the like.

The substrate is not particularly limited. Specific examples thereof include a polyester-based resin substrate formed of polyethylene terephthalate (PET) or polybutylene terephthalate (PBT); a polyolefin resin substrate formed of polyethylene or polypropylene; an organic polymer film formed of polyvinyl chloride, a fluorocarbon resin, an acrylic resin, polyamide, polycarbonate, polyimide or the like; a substrate formed of cellophane; metallic foil; a laminated film of polyimide and metallic foil; filling-effective glassine paper, parchment paper, and paper subjected to filling treatment with polyethylene, a clay binder, polyvinyl alcohol, starch or carboxymethylcellulose (CMC); and a glass substrate.

As the substrate, a substrate including an additive such as an antioxidant, an antidegradant, a filler, an ultraviolet light absorber, an antistatic agent and/or an electromagnetic wave preventive may be used within the range in which advantageous effects of the invention are not adversely affected. Moreover, as the substrate, a substrate may be subjected to, at least partly on the surface of the substrate, and when necessary, surface treatment such as corona treatment, plasma treatment or blasting, or may be provided with, on the surface, an easy-bonding layer, a protective film for a color filter or a hard coat film.

The surface of the substrate may be subjected to liquid repellent treatment using the ink of the invention, when necessary, for the purpose of obtaining a microlens having a smaller diameter and a larger height or a protective film having a higher definition pattern, or the like.

In addition, when the ink of the invention is jetted onto the substrate, particularly onto an acrylic substrate, a surface state of the substrate preferably has no unevenness (partially extremely neither lyophilic nor liquid repellent). Accordingly, the surface of the substrate is preferably subjected to surface treatment for the purpose of eliminating unevenness on the surface of the substrate.

A thickness of the substrate is not particularly limited, and is ordinarily about 10 micrometers to about 4 millimeters, and although the thickness is appropriately adjusted according to a use purpose, the thickness is preferably about 50 micrometers to about 2 millimeters, and further preferably about 100 micrometers to about 1 millimeter.

A ratio (H/D) of a lens height (H) to a lens diameter (D) of the microlens only needs to be appropriately selected according to a desired application, and the ratio is not particularly limited. In view of capability of producing an optical component excellent in light extraction efficiency or the like, the ratio is preferably about 0.15 or more, and further preferably about 0.16 or more.

In the invention, the term “microlens having an improved shape” refers to a microlens having a substantially circle shape (including a true circle shape), and having the ratio of the lens height to the lens diameter in the above-described range, for example.

In the microlens, optical transmittance at a wavelength of 400 nanometers in a photocured uniform film having 1 micrometer to 5 micrometers is preferably about 98% or more, and further preferably about 98.5% or more.

### 3. Optical Component or an Electronic Component

The optical component of the invention is not particularly limited, as long as the component has the microlens, but a component in which the microlens is provided on the substrate is preferred.

Specific examples of such an optical component include a light guide plate for a video display apparatus, and a lens substrate for a 3D image display device.

Moreover, a semiconductor package or a flexible wiring board of the invention is not particularly limited, as long as the package or the board has the protective film, but a component in which the protective film is provided on the substrate is preferred.

Specific examples of such an electronic component include a wafer level package mounted with a buffer coat, a redistribution insulating material, a dam material or an underfill material, and a flexible wiring board mounted with a cover lay.

### 4. Apparatus

The apparatus of the invention includes the optical component or the electronic component.

Specific examples of such an apparatus include a display, an illumination and a 3D display device.

The light guide plate is built in to a backlight, whereby a liquid crystal display for a liquid crystal display device can be prepared, for example, and a configuration having the light guide plate, and LED light source units with high-brightness LEDs built-in in both ends of the light guide plate is formed, whereby an LED illumination can be prepared.

The lens substrate is built in to the display, whereby a video is formed to emerge in space, and therefore a 3D display capable of displaying a three-dimensional image without wearing 3D glasses can be constructed.

### EXAMPLES

Hereinafter, the invention will be described more specifically based on Examples, but the invention is not limited to the Examples.

Each of physical properties in Examples was measured under conditions described below.

### (i) Viscosity

Viscosity (at 25° C.) was measured by using a cone-plate type (E type) viscometer (TV-22, made by Toki Sangyo Co., Ltd.). In addition, as a cone plate, a 1° 34′×24R cone plate was used.

### (ii) Nonvolatility

An evaluation solution was prepared by mixing monofunctional (meth)acrylate (B) and pentaerythritol tetra (tri)acrylate (M305) at a weight ratio of 25:45 in monofunctional (meth)acrylate (B): pentaerythritol tetra (tri)acrylate.

(1) Weight of a 5 cm×5 cm glass substrate is measured.

(2) The evaluation solution is added dropwise onto the glass substrate in step (1), and applied to be 25 mg±2 mg in an application weight error by spin coating.

(3) Weight of the glass substrate applied with the evaluation solution in step (2) is measured.

(4) The weight measured in step (1) is subtracted from the weight measured in step (3) to calculate application weight of the evaluation solution.

(5) The glass substrate applied with the evaluation solution in step (3) is heated for 15 minutes on a hot plate at 50° C.

(6) Weight of the glass substrate after being heated in step (5) is measured, and a residue of the evaluation solution is calculated by subtracting the weight in step (1).

(7) Nonvolatility is calculated from the following calculation formula.

Nonvolatility %=(residue/application weight)×100

### Jetting Characteristics Evaluation

Photocurable inkjet inks according to Examples 4 to 9 and Comparative Examples 12 to 13 were used, and (iii) evaluation of inkjet jetting stability and (iv) evaluation of rejettability were conducted under conditions described below.

Application method: inkjet printing

Printer: DMP-2831 (made by FUJIFILM Dimatix, Inc.)

Head: DMC-11601 (made by FUJIFILM Dimatix, Inc.)

Printing conditions: head temperature: 50° C. (Example 9), 40° C. (Example 4, 5 and 8, Comparative Examples 12 and 13), 35° C. (Examples 6 and 7), jetting rate: 5 m/s, driving waveform Dimatix Model Fluid 2, driving frequency: 5 kHz.

(iii) Evaluation of Inkjet Jetting Stability (Continuous Jetting Stable Time)

Jetting of an ink (thermosetting resin composition) was started from an inkjet head, and a jetting state was observed with a CCD camera attached to the printer. A time from start of jetting to finding of a nozzle having defective jetting such as non-jetting and inclination of a jetting direction was taken as a continuous jetting stable time.

In Table 2, in a column of the continuous jetting stable time, a symbol “>X” means no occurrence of the nozzle having defective jetting at a time point when X minutes elapsed, and a symbol “≤X” means occurrence of the nozzle having defective jetting at the time point when X minutes elapsed.

### (iv) Rejettability

After elapse of 1 minute from stop of jetting the ink, the ink was jetted again, and a jetting state was observed. When defective jetting was not found, the ink was jetted again after elapse of 3 minutes from stop of jetting, and a jetting state was observed. In a similar manner, rejettability was also evaluated for states after elapse of 5 minutes, 7 minutes and 10 minutes to measure an elapsed time until defective jetting was found. In Table 2, a numerical number shown in a column of rejettability shows the elapsed time when defective jetting was found, and a symbol “>10” shows no finding of defective jetting when the ink was rejetted at a time point when 10 minutes elapsed after stop of jetting.

### (v) Light Exposure

A light exposure was measured at a wavelength of UV-A (315 to 380 nm) by using an illuminance meter (UVpad-E, made by Argo Corporation).

### (vi) Curability

Stickiness of the cured film was evaluated as described below.

Good: no stickiness on a surface of the cured film in tactile impression

Poor: sticky in tactile impression

Names of reaction raw materials and solvents used in Examples and Comparative Examples are shown using abbreviations. The abbreviations are used in the following description.

### Component (A)

M305: a mixture of pentaerythritol tetraacrylate and pentaerythritol triacrylate (made by TOAGOSEI CO., LTD.)

M309: trimethylolpropane triacrylate (made by TOAGOSEI CO., LTD.)

M208: bisphenol F EO-modified diacrylate (made by TOAGOSEI CO., LTD.)

### Component (B)

VEEA: 2-(2-vinyloxyethoxy)ethyl acrylate (made by Nippon Shokubai Co., Ltd.)

4HBA: 4-hydroxybutyl acrylate

V #150D: tetrahydrofurfuryl alcohol acrylic acid multimer ester (made by OSAKA ORGANIC CHEMICAL INDUSTRY, LTD.)

### Monofunctional (Meth)Acrylate Serving as Comparative Examples Relative to Component (B)

FA-513AS: dicyclopentanyl acrylate (made by Hitachi Chemical Co., Ltd.)

FA-513M: dicyclopentanyl methacrylate (made by Hitachi Chemical Co., Ltd.)

THFMA: tetrahydrofurfuryl methacrylate

THFA: tetrahydrofurfuryl acrylate

CHMA: cyclohexyl methacrylate

CHA: cyclohexyl acrylate

SR217: 4-tert-butylcyclohexyl acrylate (made by SARTOMER)

MEDOL-10: (2-methyl-2-ethyl-1,3-dioxolane-4-yl)methyl acrylate (made by OSAKA ORGANIC CHEMICAL INDUSTRY, LTD.)

FX-AO-MA: methyl 2-(allyloxymethyl)acrylate (made by Nippon Shokubai Co., Ltd.)

ACMO: N-acryloyl morpholine (made by KJ Chemicals Corporation)

### Component (C)

IC 127: 2-hydroxy-1-{4-[4-(2-hydroxy-2-methyl-propionyl)-benzyl]phenyl}-2-methyl-propane-1-one (made by BASF SE)

IC 1173: 2-hydroxy-2-methyl-1l-phenyl-propane-1-one (made by BASF SE)

IC 379: 2-(dimethylamino)-2-[(4-methylphenyl)methyl]-1-[4-(4-morpholinyl)phenyl]-1-butanone (made by BASF SE)

### Surfactant

BYK-342: polyether-modified polydimethylsiloxane (made by BYK Japan KK)

F-444: perfluoroalkyl ethylene oxide adduct (made by DIC Corporation)

TEGORAD 2100: silicon-modified acrylate (made by Evonik Degussa AG)

### Example 1

### Preparation of Evaluation Solution 1

Evaluation solution 1 was obtained by mixing and dissolving materials shown below.

Pentaerythritol tetra (tri)acrylate (M305 was used) 4.5 g

(B) VEEA 2.5 g

Viscosity of evaluation liquid 1 was 31.7 mPa·s, and nonvolatility was 80.0%.

### Examples 2 to 3, Comparative Examples 1 to 11

Evaluation solutions 2 to 14 were prepared in the same manner as in Example 1 except that materials shown in Table 1 were used in place of monofunctional monomer (B), and viscosity and nonvolatility were measured.

TABLE 1

| | Pentaerythritol | B and | | (i) | |
|---|---|---|---|---|---|
| | tetra | comparative | | Viscosity | (ii) |
| | (tri)acrylate | component | Surfactant | (mPa · s) | Nonvolatility |
| Example 1 | M305 | VEEA | BYK-342 | 31.7 | 80.0% |
| Example 2 | M305 | V#150D | BYK-342 | 58.4 | 80.3% |
| Example 3 | M305 | 4HBA | BYK-342 | 49.3 | 82.5% |
| Comparative | M305 | THFA | BYK-342 | 32.2 | 61.3% |
| Example 1 | | | | | |
| Comparative | M305 | THFMA | BYK-342 | 34.8 | 63.4% |
| Example 2 | | | | | |
| Comparative | M305 | CHA | BYK-342 | 30.4 | 62.2% |
| Example 3 | | | | | |
| Comparative | M305 | CHMA | BYK-342 | 31.8 | 61.1% |
| Example 4 | | | | | |
| Comparative | M305 | FX-AO-MA | BYK-342 | 18.7 | 60.1% |
| Example 5 | | | | | |
| Comparative | M305 | MEDOL-10 | BYK-342 | 60.8 | 67.7% |
| Example 6 | | | | | |
| Comparative | M305 | IBXA | BYK-342 | 80.5 | 61.8% |
| Example 7 | | | | | |
| Comparative | M305 | SR217 | BYK-342 | 92.4 | 72.2% |
| Example 8 | | | | | |
| Comparative | M305 | FA-513AS | BYK-342 | 87.5 | 81.4% |
| Example 9 | | | | | |
| Comparative | M305 | FA-513M | BYK-342 | 90.6 | 86.6% |
| Example 10 | | | | | |
| Comparative | M305 | ACMO | BYK-342 | 105.2 | 83.6% |
| Example 11 | | | | | |

As shown in Table 1, in Examples 1 to 3, viscosity was 70 mPa·s or less and nonvolatility was 75% or more, too, and therefore the evaluation solutions are suitable for forming a fine pattern shape as a photocurable inkjet ink.

In Comparative Examples 1 to 6, while viscosity was 70 mPa·s or less, nonvolatility was 75% or less, and therefore when a product was used as an inkjet ink, conceivably, the fine pattern shape drawn is impaired by volatilization of the monofunctional monomer, and a stable pattern shape is hard to obtain.

In Comparative Examples 7 and 8, viscosity was 70 mPa·s or more and nonvolatility was 75% or less, and therefore when a product was used as an inkjet ink, conceivably, stable jetting is difficult owing to nozzle clogging or the like, and the fine pattern shape drawn is impaired by volatilization of the monofunctional monomer, and a stable pattern shape is hard to obtain.

In Comparative Examples 9 to 11, viscosity was 70 mPa·s, and nonvolatility was 75% or more, and therefore when a product was used as an inkjet ink, stable jetting is conceivably difficult owing to nozzle clogging or the like.

### Example 4

### Preparation of Evaluation Solution 4

Photocurable ink 4 was obtained by mixing and dissolving materials described below.

(A) M305 7.00 g

(B) VEEA 5.10 g

(C) IC127 0.85 g

(Surfactant) F-444 0.0045 g

Viscosity of photocurable ink 4 was 29.2 mPa·s.

### Preparation of a Cured Film

Photocurable ink 4 obtained was applied onto a PET film (thickness: 50 μm, brand name: Cosmoshine A4300, made by TOYOBO CO., LTD.) by using a coating rod (#3, made by R. D. Specialties Corporation).

The coat obtained was irradiated with ultraviolet light at illuminance of 500 mW/cm² and a light exposure of 500 mJ/cm² by using a conveyor type UV irradiation system attached with a metal halide lamp (M08-L41, rating: 160 W/cm, made by IWASAKI ELECTRIC CO., LTD.) to obtain a transparent cured film. A film thickness of the cured film measured by using a digital length measuring system (DIGIMICRO MF-501, made by Nikon Corporation) was 3 micrometers.

### Evaluation of a Cured Film

Curability of the cured film obtained was evaluated.

The above results are shown in Table 2.

### Examples 5 to 9 and Comparative Examples 12 and 13

Photocurable inks 5 to 9 and photocurable inks 12 to 13 were prepared in the same manner as in Example 4 except that materials shown in Table 2 were used. Viscosity of photocurable inks 5 to 9 and photocurable inks 12 and 13 were measured.

Photocurable inks 5 to 9 and photocurable inks 12 and 13 were used to prepare cured films in the same manner as in Example 4, and curability of the cured film was evaluated. The results were collectively shown in Tables 2 and 3.

TABLE 2

| | | | | | | Comparative |
|---|---|---|---|---|---|---|
| | | Example 4 | Example 5 | Example 6 | Example 7 | Example 12 |
| A | M305 | 7.00 | 9.18 | 5.25 | | 7.00 |
| | M309 | | | | 7.00 | |
| B and | VEEA | 5.10 | 5.10 | 7.00 | 5.10 | |
| comparative | THFA | | | | | 5.10 |
| component | | | | | | |
| C | IC 127 | 0.85 | | 0.86 | 0.85 | 0.85 |
| | IC 1173 | | 1.00 | | | |
| Surfactant | F444 | 0.0045 | 0.0046 | 0.0039 | 0.0039 | 0.0045 |

| | | | | | |
|---|---|---|---|---|---|
| (i) Viscosity (mPa · s) | 29.2 | 28.7 | 14.9 | 15.4 | 30 |
| (iii) Continuous jetting | 7 | 7 | >10 | 7 | 3 |
| stable time (min) | | | | | |
| (iv) Rejettability | 5 | 5 | 7 | 5 | 1 |
| stop hold time (min) | | | | | |
| (v) Light exposure | 500 | 500 | 500 | 500 | 500 |
| (mJ/cm²) | | | | | |
| (vi) Curability | Good | Good | Good | Good | Good |

TABLE 3

| | | | | Comparative |
|---|---|---|---|---|
| | | Example 8 | Example 9 | Example 13 |
| A | M208 | 6.00 | 6.00 | 6.00 |
| B and | VEEA | 4.30 | 8.00 | |
| comparative | FA 513M | 9.60 | 6.00 | 6.00 |
| component | CHMA | | | 8.00 |
| C | IC 379 | 4.00 | 4.00 | 4.00 |
| Surfactant | TEGORAD 2100 | 0.024 | 0.024 | 0.024 |

| | | | |
|---|---|---|---|
| (i) Viscosity (mPa · s) | 24.6 | 35.2 | 23.4 |
| (iii) Continuous jetting | 7 | 7 | 3 |
| stable time (min) | | | |
| (iv) Rejettability | 5 | 5 | 1 |
| stop hold time (min) | | | |
| (v) Light exposure | 500 | 500 | 1500 |
| (mJ/cm²) | | | |
| (vi) Curability | Good | Good | Good |

As shown in Table 2, in Examples 4 to 9, the inks have low viscosity at room temperature, are excellent in continuous jetting stability and rejettability by inkjet, and have sufficient curability, and therefore are suitable for forming a fine pattern shape by an inkjet method. On the other hand, in Comparative Examples 12 and 13, the inks are insufficient in continuous jetting stability and rejettability by inkjet, and therefore are unsuitable for pattern formation by the inkjet method.

### INDUSTRIAL APPLICABILITY

As described above, a photocurable inkjet ink of the invention has low volatility, in which inkjet continuous jettability and rejettability are improved, and therefore the ink is useful for forming a fine pattern shape for a microlens, a protective film or the like.

1. A photocurable inkjet ink, containing polyfunctional (meth)acrylate (A), monofunctional (meth)acrylate (B) having nonvolatility of 75% or more and viscosity (25° C.) of 1 to 70 mPa·s of an evaluation solution in evaluation method 1, and photopolymerization initiator (C); and having viscosity (at 25° C.) of 1 to 100 mPa·s, wherein
Evaluation Method 1
monofunctional (meth)acrylate (B) and pentaerythritol tetra (tri)acrylate are mixed at a weight ratio of 25:45 in monofunctional (meth)acrylate (B): pentaerythritol tetra (tri)acrylate to prepare the evaluation solution,
(1) weight of a 5 cm×5 cm glass substrate is measured,
(2) the evaluation solution is added dropwise onto the glass substrate in step (1), and applied to be 25 mg±2 mg in an application weight error by spin coating,
(3) weight of the glass substrate applied with the evaluation solution in step (2) is measured,
(4) the weight measured in step (1) is subtracted from the weight measured in step (3) to calculate application weight of the evaluation solution,
(5) the glass substrate applied with the evaluation solution in step (3) is heated for 15 minutes on a hot plate at 50° C.,
(6) weight of the glass substrate after being heated in step (5) is measured, and a residue of the evaluation solution is calculated by subtracting the weight in step (1) therefrom, and
(7) nonvolatility is calculated from the following calculation formula: nonvolatility %=(residue/application weight)×100.

2. The photocurable inkjet ink according to claim 1, wherein polyfunctional (meth)acrylate (A) is at least one compound selected from the group of compounds represented by formula (1) or formula (3): 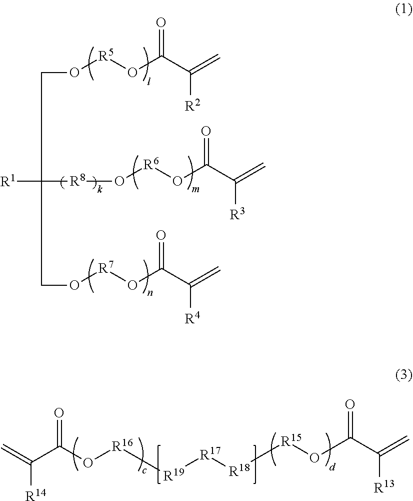
wherein, in formula (1), R¹ is hydrogen, alkyl having 1 to 6 carbons or hydroxymethyl, R², R³ and R⁴ are independently hydrogen or methyl, R⁵, R⁶, R⁷ and R⁸ are independently alkylene having 1 to 6 carbons, k is 0 or 1, and 1, m and n are independently an integer from 0 to 10; moreover, in formula (3), R¹³ and R¹⁴ are independently hydrogen or methyl, R¹⁵ and R¹⁶ are independently alkylene having 1 to 6 carbons, R¹⁷ is a divalent organic group or a single bond, and R¹⁸ and R¹⁹ are independently —O— or a single bond, in which, when R¹⁷ is a single bond, one of R¹⁸ and R¹⁹ is —O— or both thereof is a single bond; and c and d are independently an integer from 0 to 10.

3. The photocurable inkjet ink according to claim 2, wherein polyfunctional (meth)acrylate (A) is a compound in which, in formula (1), k is 0 or 1, and a sum: 1+m+n is 0, or a compound in which, in formula (3), R¹⁵ and R¹⁶ each are alkylene having 2 carbons.

4. The photocurable inkjet ink according to claim 3, wherein polyfunctional (meth)acrylate (A) is at least one compound selected from glycerol tri(meth)acrylate, trimethylolethane tri(meth)acrylate, trimethylolpropane tri(meth)acrylate, pentaerythritol tri(meth)acrylate, bisphenol A ethylene oxide-modified diacrylate and bisphenol F ethylene oxide-modified diacrylate.

5. The photocurable inkjet ink according to claim 4, wherein polyfunctional (meth)acrylate (A) is pentaerythritol tri(meth)acrylate or bisphenol F ethylene oxide-modified diacrylate.

6. The photocurable inkjet ink according to claim 1, wherein monofunctional (meth)acrylate (B) is a compound having one group selected from a vinyl ether group and an allyl ether group.

7. The photocurable inkjet ink according to claim 6, wherein monofunctional (meth)acrylate (B) is a compound represented by formula (2): 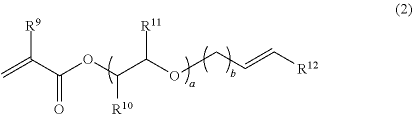
wherein, in formula (2), R⁹ is hydrogen or methyl, R¹⁰ and R¹¹ are independently hydrogen or methyl, a is an integer from 1 to 10, b is 0 or 1, and R¹² is hydrogen or alkyl having 1 to 11 carbons

8. The photocurable inkjet ink according to claim 7, wherein, in formula (2), R¹⁰ and R¹¹ are hydrogen, a is an integer of 1 or 2, b is 0, and R¹² is hydrogen.

9. The photocurable inkjet ink according to claim 8, wherein monofunctional (meth)acrylate (B) is 2-vinyloxyethyl (meth)acrylate or 2-(2-vinyloxyethoxy)ethyl (meth)acrylate.

10. The photocurable inkjet ink according to claim 9, wherein monofunctional (meth)acrylate (B) is 2-(2-vinyloxyethoxy)ethyl (meth)acrylate.

11. The photocurable inkjet ink according to claim 1, containing 10 to 75% by weight of polyfunctional (meth)acrylate (A), 20 to 90% by weight of monofunctional (meth)acrylate (B), and 1 to 20% by weight of photopolymerization initiator (C) (in which a total is not more than 100% by weight), based on total weight of the photocurable inkjet ink.

12. A cured film, formed of a cured material of the photocurable inkjet ink according to claim 1.

13. A microlens, formed of the cured material of the photocurable inkjet ink according to claim 1.

14. A protective film, formed of the cured material of the photocurable inkjet ink according to claim 1.

15. An optical component, comprising the microlens according to claim 13.

16. An electronic component, comprising the protective film according to claim 14.

17. A display device, comprising the optical component according to claim 15.

18. A display device, comprising the electronic component according to claim 16.
